(19) United States
(12) Patent Application Publication
(10) Pub. No.: US 2025/0139719 A1
(43) Pub. Date: May 1, 2025

(54) Method of automation of restaurant traffic management process

(71) Applicant: Papukurier sp. z o.o., Poznan (PL)

(72) Inventors: Emil KONRAD, Poznan (PL); Michal STRECKER, Poznan (PL)

(21) Appl. No.: 18/384,776

(22) Filed: Oct. 27, 2023

(30) Foreign Application Priority Data
Oct. 25, 2023 (PL) P.446490

(51) Int. Cl. G06Q 50/12; G06Q 10/067

(52) U.S. Cl. CPC G06Q 50/12; G06Q 10/067

(57) ABSTRACT

The invention is a method of automation of restaurant traffic management process, for the delivery of meals by couriers from the restaurant to clients located beyond the premises of the restaurant where quantitative data on the movement of restaurant kitchen personnel and on the movement of couriers is collected and subsequently restaurant operations scenarios are identified by way of the clustering and classification of this data, and then this data is introduced into a simulator, where it is used for the purposes of a previously unknown series of orders placed during one day, wherein the meal preparation and courier travel times are drawn randomly from a statistical distribution. Data from the simulator is then processed into data for restaurant traffic control with the use of at least one decision-making algorithm and can be applied for the management of restaurant traffic.

### DETAILED DESCRIPTION

The present invention relates to the method of automation of the process of restaurant traffic management, including the reception of orders, preparation and delivery of meals from the restaurant to clients who are beyond the restaurant's premises by couriers (the ‘takeaway’ model).

The functioning of a restaurant that operates in accordance with the ‘takeaway’ model is characterised by the extensive variability of the restaurant's internal environment (the kitchen) as well as its surroundings (the area of delivery of meals by the restaurant), which is dynamic in nature and depends on various factors. The number of orders is affected not only by the time of the day or the day of the week, but also by other random factors (such as rainy weather that detracts clients from leaving their houses, sports-related events generating more social activity, etc.), the batches of generated products are very short, the composition of these products is often selected individually (e.g. depending on the degree of doneness, the presence of spices, the absence of specific allergens, etc.) Deliveries can be processed according to various procedures, depending on the proximity of the delivery locations, deliveries ordered within a relatively short time span can be combined, the delivery process depends on the time of day, the weather, road traffic congestion, the number of couriers, or on their operating efficiency. Therefore the planning of the operations of a business such as a restaurant requires the solution of a number of practical issues.

The present invention relates to the method of automation of the process of taking orders, preparation and delivery of meals offered in the ‘takeaway’ format by the restaurant, using the mathematical description of processes taking place at each operational stage of a restaurant. The method according to the invention uses elements of probabilistic analysis of the response time to orders, with the particular consideration of probabilistic interval algebra and the method of creation of digital twins of smart companies, which facilitated the development of a simulation/testing environment distinguished by the possibility of the analysis of factors previously not considered in scientific research. The method according to the invention takes into account the probabilistic nature of the times of duration of all successive operational phases of a restaurant and the mutual relations between the kitchen and the deliveries within the order delivery process. The method according to the invention also takes into account new, previously omitted factors that affect the functioning of a restaurant, such as the consideration of the time of duration of individual operations as distributed rather than constant values; additionally a model of the synchronisation of the operations of couriers and chefs has been developed, therefore the effects of the implementation of algorithms and models are much more precise and facilitate a much more realistic simulation of a restaurant's operating conditions. The present method also implements reinforcement learning technology for the planning of a restaurant's operations, i.e. predictive algorithms have been implemented to determine delivery times (promise times) declared when a customer places his/her order, which contrary to the currently used algorithms is based not only on historical data that only takes into account the courier's operations, but is also based on the indications of the planning algorithm and on the kitchen data, which allows the determination of a possibly realistic promise time and to achieve higher customer satisfaction.

The method according to the invention uses historical data on work organisation methods and on data flow from the preparation and order delivery processes in restaurants operating on the basis of the ‘takeaway’ model, and compiles data obtained from various types of restaurants related to traffic present in the restaurant's staff area and to any possible decision-making situations and describes them in a quantitative way. Data related to couriers was obtained via the Global Positioning System (GPS), whereas the restaurant's internal traffic was analysed using a specially developed environment for the acquisition of kitchen data, with the implementation of an appropriate gradation of kitchen operations which should be registered in terms of their significance, through the selection and arrangement of equipment in the kitchen, software preparation and its activation at testing stations. Data was collected from partners-restaurant operators, during the performance of real-life restaurant activities. Information obtained on the details of kitchen activities and on the delivery of orders was processed in a way that made it useful for the purposes of mathematical modelling of a restaurant's operations, which included the creation of a simulator and predictive and decision-making algorithms (planning) that could be useful in the optimisation process.

The data collection stage in accordance with the invention includes the selection of restaurants for data acquisition, the definition of requirements for data acquisition system software and hardware with the consideration of the restaurant's technical characteristics, the preparation of a testing station for the performance of data acquisition system tests, the performance of tests of hardware and software configuration in a pre-prepared testing environment and the obtaining/acquisition of data from delivered orders. Data obtained from restaurants is then processed, analysed and combined with data related to courier traffic, with the subsequent analysis of the consistency and quality of the obtained data and its identification using the methods of clustering and classification of typical restaurant operational scenarios, wherein data is processed using statistical and machine learning (kernel density estimation, Markov models, Gaussian mixtures) methods, in order to obtain the quantitative description of collected data. Data obtained during this process is then transformed into databases.

The obtained and processed data, which represents the description of the trial decision-making policy, is then introduced into a simulator with the application of previously unknown series of orders taken during a single day. The individual preparation times of dish X, travel times to address Y are randomly drawn from the statistical distribution that approximates data measured during the data acquisition phase (in terms of kitchen operations) or historical data (in terms of delivery times). The selected policy defines which chef (employee) is to start working on a specific dish, at which time food is to be delivered by the courier and the delivery route. A decision-making policy is evaluated on the basis of profiles such as cumulative, average and the worst case of delivery waiting time, the conformity of the actual time of preparation and delivery with the time promised to the client, or the expected rating of delivery.

The simulator consists of the following modules: the kitchen, deliveries and the configurator. The kitchen module is a digital twin of a real kitchen, which simulates its resources, their quantity, its main parameters and the dependencies between them. Tasks are shown in the simulator in the form of a structured acyclic graph, where nodes represent sub-tasks, while edges—the dependencies between the sub-tasks. Task graphs are defined on the basis of the results of the data acquisition stage, while sub-tasks are characterised by the list of the required resource types and the delivery time (described using probability distribution), wherein the dependencies between sub-tasks are described using interval algebra (e.g. Allen's).

Additionally, the simulator enables the simultaneous assignment of a sub-task to many different resources, the mutual exclusion of the use of resources, as well as operations on resources dependant on a sequence of sub-tasks. The simulator enables the reliable assessment of management policies for both large restaurants in city centres, as well as for smaller food outlets in small towns with variable traffic. Configurable parameters include: the restaurant menu, meal preparation timetable, stove output, capacity and speed of vehicle used for deliveries, the number of chefs, or the number of couriers.

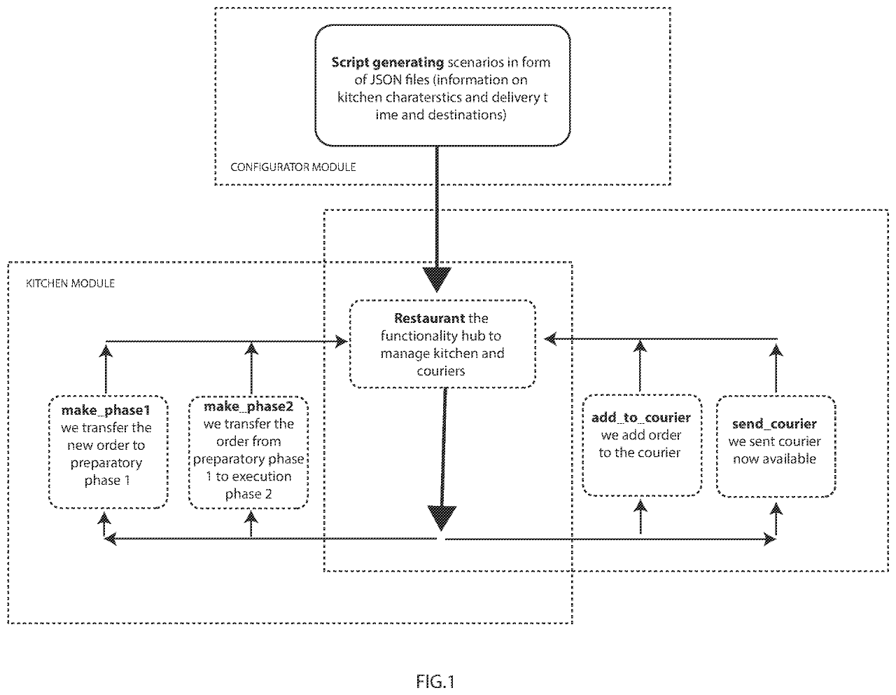

The simulator includes a programming tool with information on kitchen resources and their status, which implements the logic of incoming orders and has an interface for the management of current orders. The simulator is controlled by events (there is no constant simulation step), wherein an event is understood for example as a chain of events: the restaurant receives a new order, the status of the processed order is updated. Subsequent events are stored in a priority queue, where the time of event determines the sequence of further simulation steps (earlier time=higher priority). Two parameters are assigned to each order, i.e. the time that the chef need to prepare the order and the time needed for thermal processing. Due to technical requirements, each order received by the system is given its own identifier. The number of identifiers is determined initially during the configuration of the simulator and represents the number of orders that can be processed simultaneously. A diagram of the simulator's structure has been shown in FIG. 1 of the drawings.

An order can have one of the following specific statuses: 1) newly received order, 2) order is being prepared by the chef, 3) order ready for thermal processing, 4) order during thermal processing, 3) kitchen has finished working on the order, 5) order assigned to one of the active couriers, 6) order is being delivered, as well as information on the duration times of all stages, as well as their current status. When a newly received order is transferred to the delivery phase, a chef is assigned to one of the new orders so that he/she can prepare it appropriately before its thermal processing (phase 1 of the order). If this instruction is initiated for an order that has a status other than a newly received order, or if the kitchen does not currently have the required amount of available resources, the action will be registered as unacceptable and the simulation step will not be executed. But if the order has the correct status and the quantity of available resources is above zero, the order will be transferred to the events queue with an appropriately calculated stage completion time and upon the selection of the event from the queue, the order will be prepared (phase 2 of the order) and will receive a subsequent status in the sequence of increments. Due to the event-driven architecture, instead of defining a permanent simulation step, the developed module inherently ensures the possibility of simulating kitchen operations with unrestricted precision (it is restricted only by the resolution of the variable that defines the time of event).

When the order is transferred to the thermal processing stage, a stove is assigned to the order and as in the previous step, the amount of resources must be non-zero and the status of the order must be as expected (before the second phase), so that the action is not registered as incorrect. Following the correct processing of the status, the order, as in the previous phase, is added to the queue with a calculated time of completion of the current phase, and upon its selection from the queue the kitchen finishes its work on the order and it is ready for delivery, receiving therefore the next status.

Data in the simulator is structured in the form of status vectors, which contain all necessary information related to the ability of the restaurant to perform a new activity via the decision-making module. The vectors contain information on all current orders, i.e. the current phase of the order, whether it can be transferred to the next phase, etc., as well as information on available resources such as chefs, stoves and couriers. The status can be therefore divided into two parts such as: the status of all orders and the kitchen status. The status of a single order of the index (oᵢ) has the following form:

| Is before | Is during | Is before | Is during | Is the status | Duration of | Duration of |
|---|---|---|---|---|---|---|
| phase 1 - | phase 1 - | phase 2 - | phase 2 - | ready - 0/1 | phase 1 | phase 2 |
| 0/1 | 0/1 | 0/1 | 0/1 | | | |

The kitchen status has the following form:

| | | | | | |
|---|---|---|---|---|---|
| Number of | Number of | Number of | Number of | Number of | Number of |
| all chefs | available | all stoves | available | all tables | available |
| | chefs | | stoves | | tables |

The final form of the environment status can be therefore presented as:

[o₁, o₂, . . . , oₙ, kitchen_status]

where n is the value of the maximum number of simultaneous orders.
An increment in the simulator's operation is carried out by the selection of a number in the range of between 0 and M−1, where the consecutive action means the transfer of an order to the next phase using the selected resource (depending on the phase it can be the pairs of chef and table, stove and courier). M depends therefore on the scenario parameters and is calculated using the following formula:

$$( maximum\_number \_of \_simultaneous \_orders * ( number\_of \_chefs * number\_of \_tables + number\_of \_stoves + number\_of \_couriers - 1 )$$

Kitchen resources shown above are indicated in the solution as (with the consideration of quantities defined by the scenario):
Chefs: k₁, . . . , k_{max_chefs}
Tables: t₁, . . . , t_{max_tables}
Stoves: s₁, . . . , s_{max_stoves}
Couriers: c₁, . . . , c_{max_couriers}
   where bottom indexes demonstrate which of the possible resources will be used upon the selection of a given action.
   The mapping from integers into specific actions can be divided into 4 sub-sections and presented as:
1. The order is transferred to the first phase using a chef and a table with a given number−actions from 0 to the number of maximum orders*number of chefs*number of tables−1:

[o₁k₁t₁, . . . , oₙk₁t₁, o₁k₂t₁, . . . , oₙk₂t₁, . . . , o₁k_{max_chefs}t₁, . . . , oₙk_{max_chefs}t₁, . . . , o₁k₁t₂, . . . , oₙ, k₁, t₂, . . . , oₙk_{max_chefs}t_{max_tables}]
For each successive trio of parameters (order, chef, table), a corresponding action is identified.
2. The order is transferred to the second phase using a selected stove:
   Actions to the number of maximum orders*number of stoves−1

[o₁s₁, . . . , oₙs₁, . . . , o₁s_{max_couriers}, . . . , oₙs_{max_stoves}]
3. Adding an order to a specific courier:
   Actions to the number of couriers−1

[o₁c₁, . . . , oₙc₁, . . . , o₁c_{max_couriers}, . . . , oₙc_{max_couriers}]
4. Suspension of the current iteration step (used when for example all orders are currently in phase 1 or 2).

Because reinforced learning is a paradigm based on the interaction with the environment, it was necessary to define a reward function, which appropriately rewards/penalises the decision-making module for the performed action. This way, on the basis of trial and error, the decision-making module can learn the optimum behaviour in a given environment. The reward function assumes the form of a bracket function in the simulator, with the possible statuses of 1) all tasks correctly completed, 2) initiation of transition to the next simulation step, even though it does not exist any more (this happens when the last order is being processed, but hasn't been dispatched yet) 3) the performance of transition to the next step that attempts to add to many active meals (it cannot be performed due to insufficient availability of resources), 4) the performance of a correct transition to the next step or the modification of order, 5) the attempt to modify a meal that does not exist or cannot be modified at that time due to the unavailability of a chef (refers to a situation in which a meal is during some kind of phase, or cannot be dispatched because other meals from this order are not ready yet) 6) the value applied to the function for the calculation of reward for the delivery of an order, additionally the duration of delivery of the given order is deducted from this value, 7) additional penalty for moving to the next event if it was first necessary to modify an order. Because of the above definitions, it is possible to treat the developed environment as a Markov Decision Process (MDP), which enables the performance of the decision-making module learning procedure via reinforced learning.

The couriers module of the simulator is responsible for the management of couriers: for the assignment of ready orders to them, for dispatching them and the calculation of the duration of the route of delivery of ready orders to the customers. An order prepared by the kitchen is assigned to a courier. If the status of a courier is not as expected, or if the courier's capacity has been exceeded, the action is registered as incorrect and the simulation step will not be performed. The correct assignment of an order to a courier causes one of the selected couriers to be dispatched with the aim of delivering the assigned orders. For the action to be correctly registered, the courier must not be delivering a previously assigned order at that time. The courier's return time is calculated and the courier is then sent to the events queue with this time and with the priority corresponding to this time. The status of all orders assigned to the dispatched courier will be updated to the order dispatched status, and subsequently their resourced will be freed and it will be possible to accept new orders in their place. The parameters of each courier include the maximum capacity and speed during delivery. Orders prepared by the kitchen and assigned to couriers are stored in a separate set, as in the case of chefs in the kitchen module. Because of this, it is very easy to check their availability, or to assign appropriate actions to them within a given simulation step.

Values related to each order are stored in the couriers module, including: the time of travel needed for the arrival at an address defined for this order from the addresses defined for all remaining orders, and the time needed for arrival from the restaurant (with and without an additional time that takes into account additional parameters). Additional parameters are understood to include: the presence of a lift/intercom at the delivery location, the floor that the courier must arrive at. Travel times between various orders depend on the function of distance, an example of which is the travel time between two points of defined geographical coordinates, in a straight line and at the constant speed of 60 km/h. The distance values matrix is updated upon the reception of a new order by the restaurant: the times of travel between all other orders, as well as between the new order and the restaurant, are calculated. The distance function does not take into account the layout of roads or the current density of traffic on these roads; the correction of values is based on the generally available routing application: the Open-source Routing Machine (OSRM). When the user enters the geographic coordinates of the desired location, the application provides a result in the form of the actual travel time. Values calculated a above are then entered into a matrix in accordance with identifiers assigned to individual orders. An order is removed from the matrix when the courier assigned to this order is dispatched. Below is an example of a matrix representing a scenario with a maximum of two orders:

| | | |
|---|---|---|
| 0 | time of travel from order | time of travel from restaurant |
| | 1 to 2 + extra time | to order 1 |
| time of travel from order | 0 | time of travel from restaurant |
| 2 to 1 + extra time | | to order 2 |
| time of travel from restaurant | time of travel from restaurant | 0 |
| to order 2 + extra time | to order 2 + extra time | |

Each order has micro-factors assigned to it, such as information about the floor number of the destination apartment, whether a lift or intercom is present, or whether the housing estate is a gated community. These parameters are generated on the basis of data processed by the configuration module. Extra time in the matrix represents additional time resulting from the consideration of such micro-factors. When the courier is dispatched, his return time is calculated into matrix values, with the combination of routes between orders assigned to him/her before the dispatch.

The aim of the configurator module is to generate scenarios on the basis of the provided parameters. The previously mentioned parameters provide information on the daily tasks of a takeaway restaurant. The configurator allows the user to generate data by directly entering specific parameters (e.g. a specified number of chefs). These parameters can also be selected using data distribution patterns developed on the basis of examples available in a data set (data collected from orders delivered by actual takeaway restaurants). These distribution pattern were developed using the Kernel Denisity Estimation method, using the publicly available scikit-learn repository and data collected from actual restaurants.

The configurator, on the basis of the defined parameters or with the application of distribution patterns, defines the following values that will be registered in a scenario: the number of orders delivered during a working day, the maximum number of orders and meals in one order, the time of order and the expected time of its delivery, opening/closing time of the restaurant, the maximum/minimum duration of phase 1 and phase 2 for each meal, the number of chefs and couriers, couriers' vehicles, the location of ordering customer (depending on the location of the restaurant). Additionally, the configurator takes into account parameters defined by the user before the generation (in a configuration file), or which are otherwise randomly selected using flat distribution (no information on this is provided in the database), namely: the location of restaurant, the number of floors, whether a lift/intercom is present, the number of stoves and tables. Parameters generated in the above manner both for the restaurant, as well as for all orders, are recorded as a restaurant's working day scenario.

The method according to the invention includes a decision-making algorithm, which is supposed to assign duties and to synchronise the tasks of chefs and couriers in a manner that is as close as possible to the optimum management of the restaurant's operations from the point of view of restaurant owners, personnel and customers. In order to achieve this, the authors have carried out a complex research of different methodologies, from simple algorithms based on a queue model, through models optimised using genetic algorithms, to the application of reinforcement learning methods.

A queue-based decision-making model operates on the basis of the first-in-first-out (fifo) principle, where orders situated at the beginning of the queue will be processed first. An order is sent to the queue if: the restaurant has received it as a new delivery request, or if the order has finished one of its preparatory stages and in that case it is sent back to the queue with an updated status and a new priority level. The individual simulation steps are as follows:
1. Checking if there are any new orders-if there are, they are added to the end of the queue.
2. If the queue is empty:
   waiting for a new order.
3. If the queue is not empty:
   exclusion of the oldest element in the queue and execution of operation to transfer the order to the next phase, where it is added to the end of the queue;
   if the excluded order is ready for dispatch, it is assigned to a given courier together with other orders assigned to him/her at an earlier stage
      So if several orders have the same status, priority is given to those orders which have spent the longest time in the queue, i.e. if it is the first stage, this refers to an order which has been ordered before the others, while in the case of further stages priority is given to the order which has completed the previous stage before the others.

Planning algorithms based on reinforcement learning were developed using tools from the publicly available MLFlow library—the monitoring of models during training, visualisation of profiles, the registration of model parameters and manually generated graphs. Profiles are downloaded once every episode using a library interface—visualisations are then generated automatically, the final evaluation profiles can be also sent in the form of a table. A trained, serialised model is also recorded for each completed action. Integration with the repository consisted of the packaging of the repository using methods derived from this library and from the publicly available Data Version Control (DVC) library-the recording of trained models, used scenarios and output values generated by the model, as well as simple ways of automation of the experiment initiation/reproduction process. The definition of the structure of experiments in a dvc.yaml file and of a set of parameters for each experiment stage in a params. yaml file allows the user to track changes in the parameters/model and in the experiment definition for an experiment, using a git-inspired interface. The execution of an experiment after configuration is reduced to a dve repro command. An experiment will be executed only if: the parameters, definition or the source code of an experiment have been changed. Another type of use is the dvc params diff command, which allows the user to reveal locally modified parameters.

An agent of the decision-making model has been developed for the purposes of the present method using the Temporal Difference (TD) Learning method, which represents a set of methods for the iterative improvement of the existing estimation of the value function with the use of three control-oriented extensions of this method (i.e. apart from the V or Q function a policy is also provided), namely DQN and SARSA and Actor-Critic (TD-AC). In The TD-AC extension, the baseline regulariser used to reduce the variance of the actor loss function is the TD Error value received by the critic, which is optimised in a similar way as in the case of Q-learning. In all three methods, the agent implements sequences of actions such as: the selection of an action using the current policy (epsilon greedy in the case of DQN and SARSA, random selection of actions using the discrete distribution of actions in the case of TD-AC), the optimisation of neuron network weights, the implementation of a learning loop, i.e. the agent performs a specified number of episodes using the target environment, and after each episode the optimising method is initiated and evaluation of the environment is performed, with the return of the total rewards received and the duration of evaluation. Using the fact that the simulator is implemented according to API OpenAI GYM, the agents can interact with the environment in a uniform way.

In the TD-AC decision-making model, the implemented decision-making models based on reinforcement learning also share most of the hyper-parameters of the learning procedure, namely: the size of hidden network layers, the size of the batch sampled from the transition buffer, the probability of randomly drawing an action (exploration vs. exploitation), the maximum value, minimum value and change step, the number of training episodes, the number of eras after which the target value is to be updated, the maximum number of actions in one scenario (episode), the learning rate of the optimiser, the minimum buffer size before training, the parameter determining the degree of focussing on rewards from future actions. Both the policy (the actor) and the critic (V-function approximation) are represented by a neural network.

In the SARSA method, the agent (a neural network in the described example) is trained on-policy, i.e. the action for the next stage is selected using the current policy, which helps to generate value Q for the calculation of the loss function. The policy itself is obtained on the basis of the approximated Q function—the action which gives the highest value of the Q function for the given status is selected. This method uses an approach with the implementation of two neural networks. Additionally, the network named as the target network is a copy of the network used for the prediction of the values of the Q function and is used to improve the stability of the process of learning by predicting the values of Q for the future status and action (not for the present status of the environment) in the Bellman equation used for the calculation of the cost function of a neural network. The parameters of the target network itself are not trained, however, but are only periodically synchronised with the main network.

In the Double-DQN method, the target network was used for the calculation of the cost function. A difference in the learning dynamic has been observed, however, because Q-Learning is an off-policy method. In the DQN method, when the next status is processed—its Q value is selected with the application of a max operator based on data sampled from a replay buffer, whereas in the SARSA method this is done on-policy and the action for the next status is selected using the current policy, which allows the generation of a Q value for the calculation of the loss function.

The results of experiments performed using the described methods were monitored by MLflow and compiled in a database, with the application of an Object Storage type MiniIO database designed for the storage of unstructured data, such as programme results/logs. This methodology proved to be sufficient, because MLflow provides an interface that manages such registered data and allows the user to easily compare the results of several experiments.

All three decision-making models were tested with the use of trial scenarios of the following parameters: number of chefs, tables and stoves: 2, number of couriers: 2,number of orders made during 8 hours: 5. The spaces of states and actions for these defined parameters in this case amounted to 51 and 51 respectively. This method was tested using different hyper-parameters, including optimisers such as: Adam, SGD, RMSProp, the features sub-module was tested using a higher number of layers from 1 to 3, with the numbers of neurons from (256->128->64), learning rate was tested on the values in the range of (1e−5, 0.1), the discount factor was tested for values in the range of (0.9, 0.99).

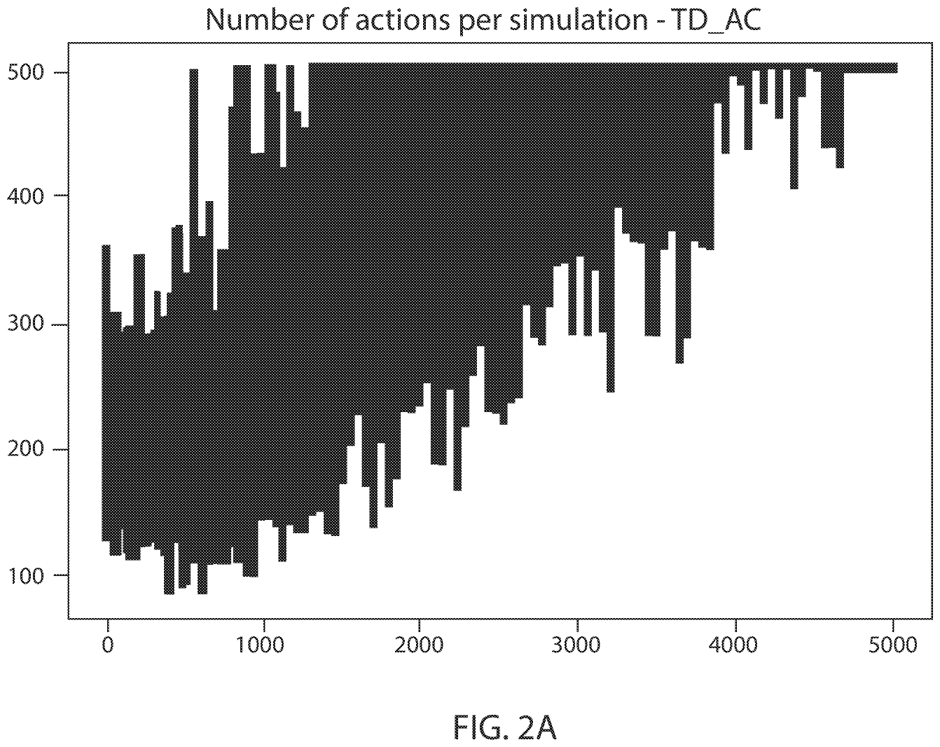

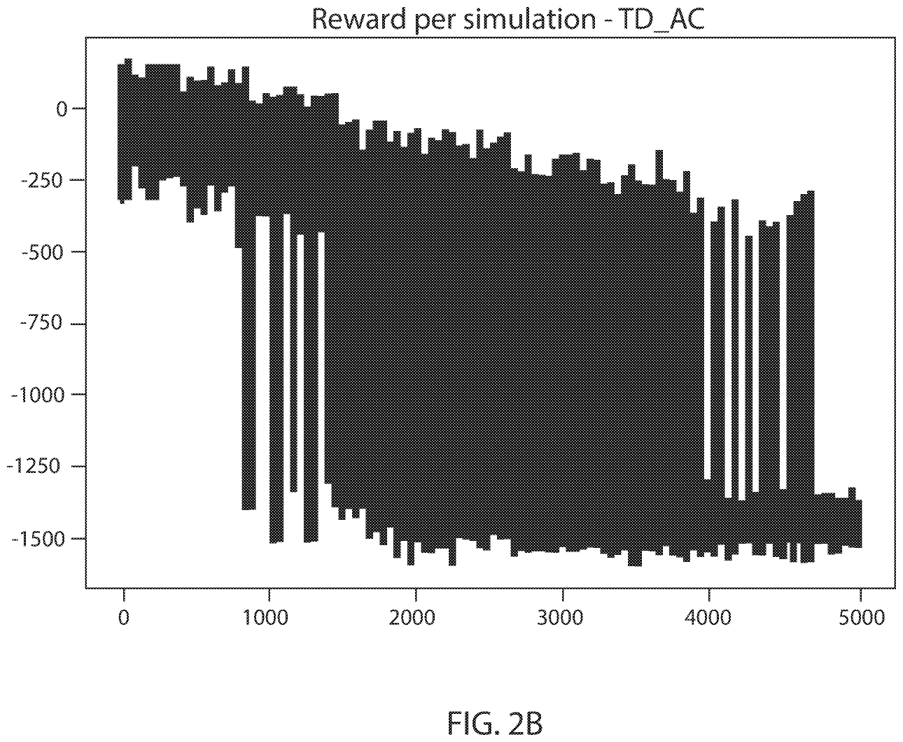

The DQN method did not generate satisfactory results. The sum of rewards even for small test scenarios generated negative values, with DQN achieving e.g. the value of ˜300. In order to verify if this is not an implementation-related problem, the Stable Baselines3 library was used, among others, and other extensions of the described methods were tested, including: A2C and PPO. The obtained results were still distant from the level of results obtained using methods in further sections, as shown in FIG. 2a, 2b of the drawings, where FIG. 2a shows the graph of the sum of rewards received for each episode, while FIG. 2b shows the number of simulation steps needed to complete an episode. The sum of rewards received by the TD-AC agent during the learning process does not increase with successive episodes (and even decreases), which during evaluation represents quality comparable with a random policy.

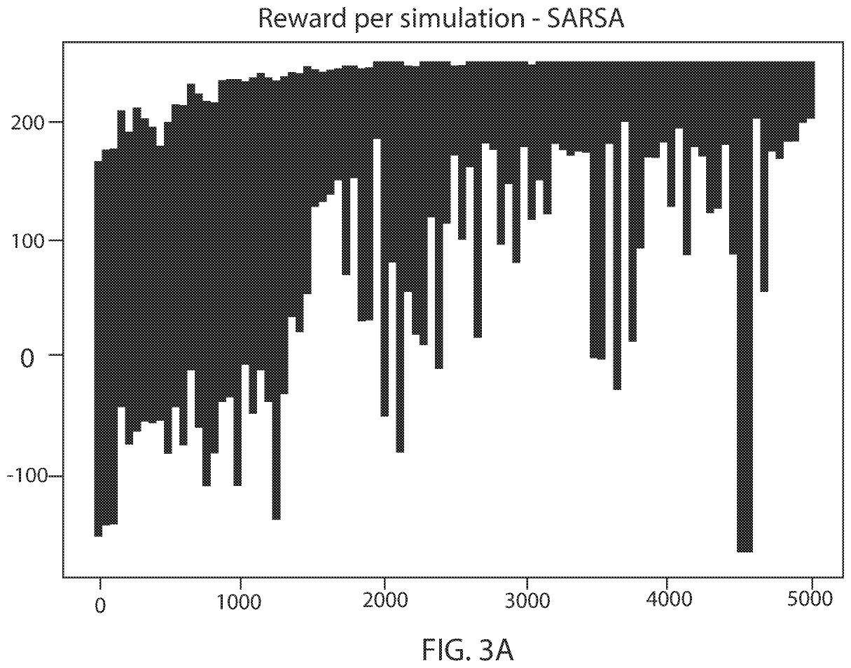

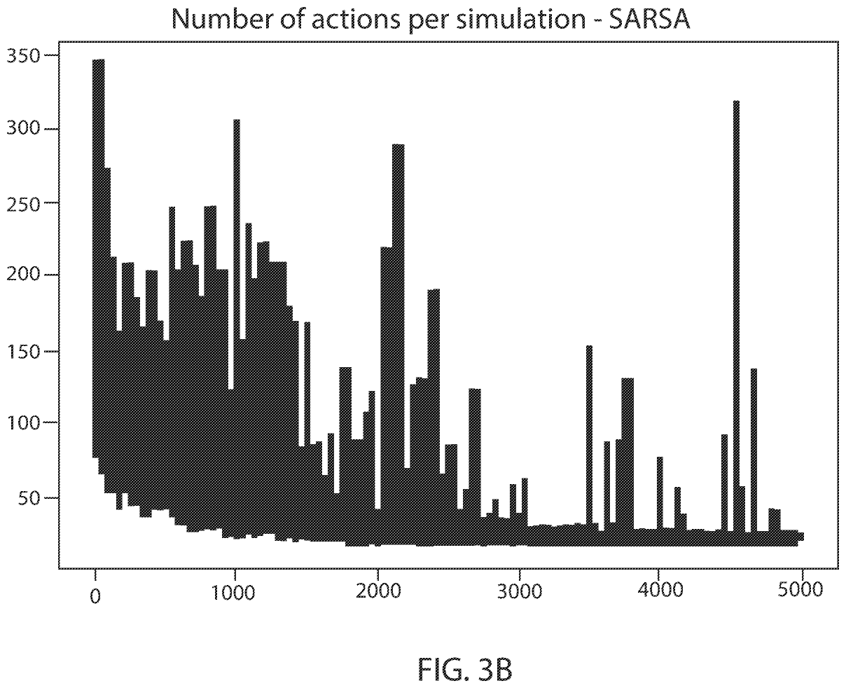

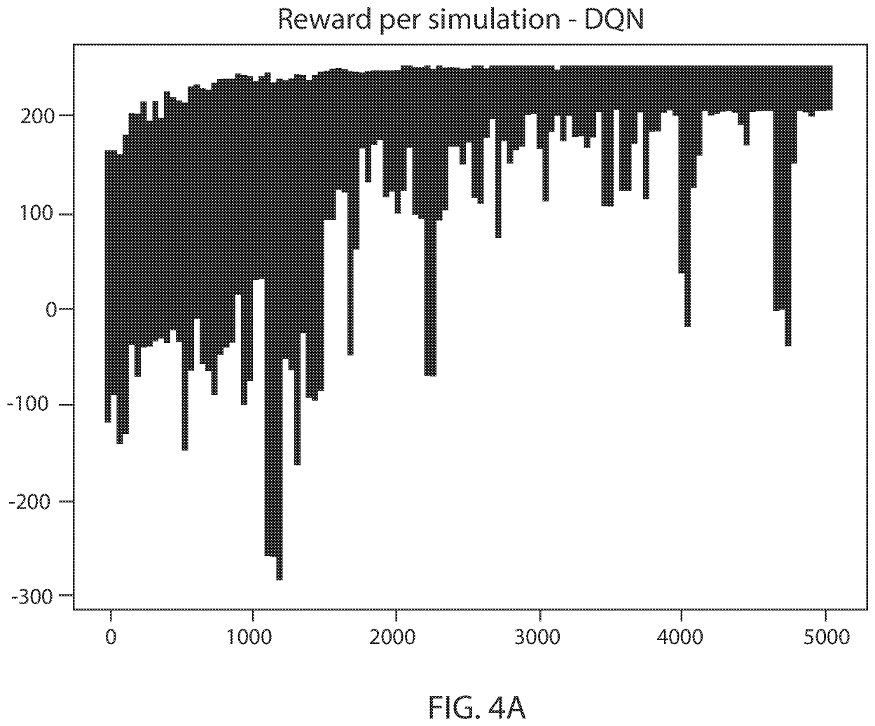

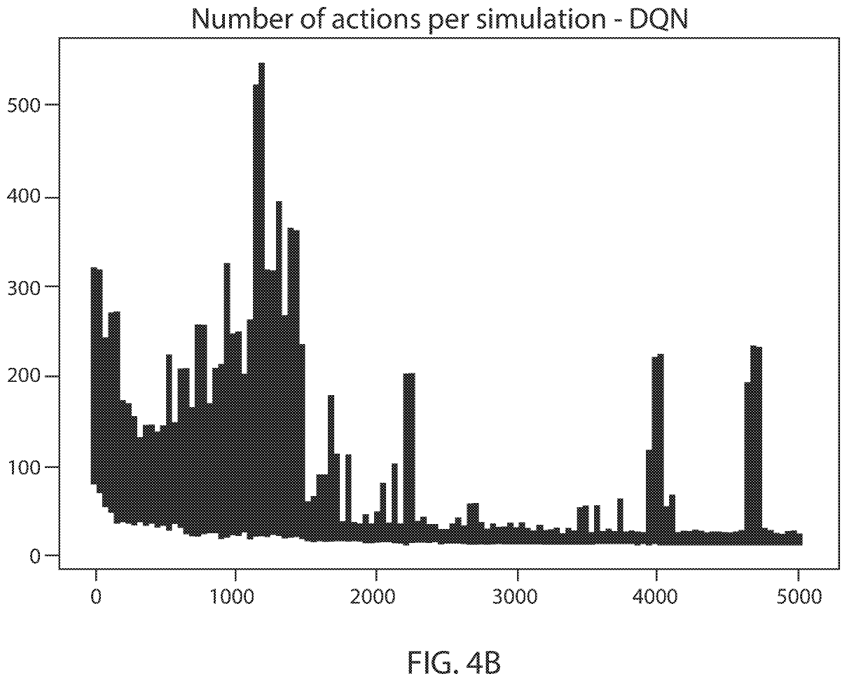

The learning procedure for SARSA and DQN methods in these scenarios, meanwhile, has demonstrated positive results, as shown for SARSA in FIG. 3a, 3b and for DQN in FIG. 4a, 4b of the drawings: the sum of rewards increases with training, the agent needs less and less steps to complete a single simulation episode and the agent can correctly execute test scenarios (the scenarios are generated using the same parameters as for scenarios used during training, but the agent sees them for the first time only during evaluation).

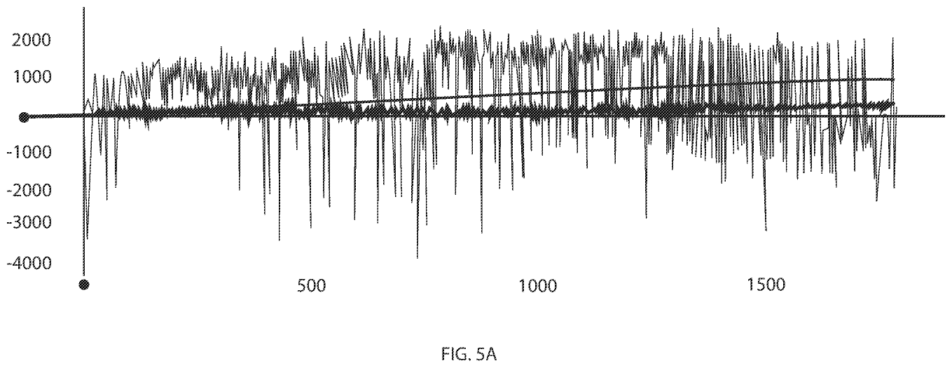

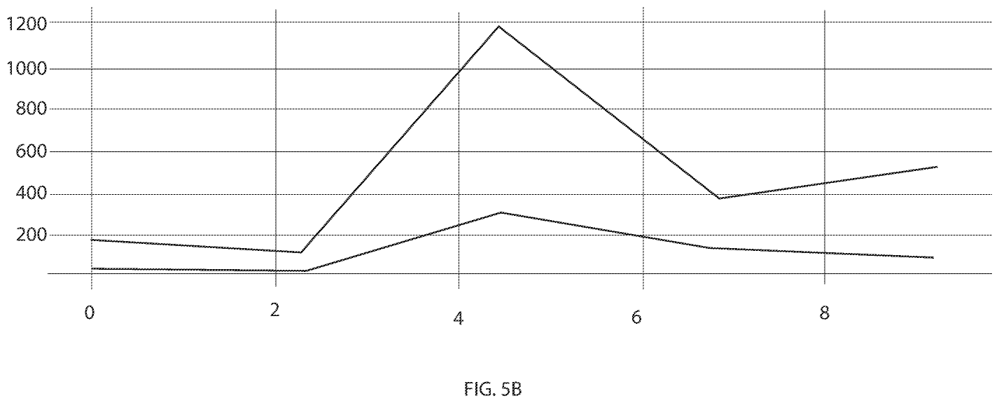

Because the TD-AC decision-making model did not provide satisfactory results even for small scenarios, and due to the fact that DQN is a more popular method, i.e. there is a much higher number of scientific papers related to this method than those related to the SARSA method, the authors decided to focus on one specific method, namely on the Q-Learning based method and a method that uses a queue as a baseline. However, a Q-Learning based model cannot solve test scenarios for a full simulator all by itself. The sums of rewards received during the learning process increase appropriately, but their variance even in the final phase is still very high, which translates into very poor results at the stage of evaluation on scenarios that were not available during training, as shown in FIG. 5a of the drawings, which shows the sum of rewards received during an episode and the number of steps needed to complete it. FIG. 5b on the other hand shows an agent during evaluation, i.e. all points of the polygonal line; this represents one of the five test scenarios. In comparison, a model that uses a queue achieves the value of rewards of ˜1200 for all test scenarios. Therefore, as a final solution, a hybrid model was proposed.

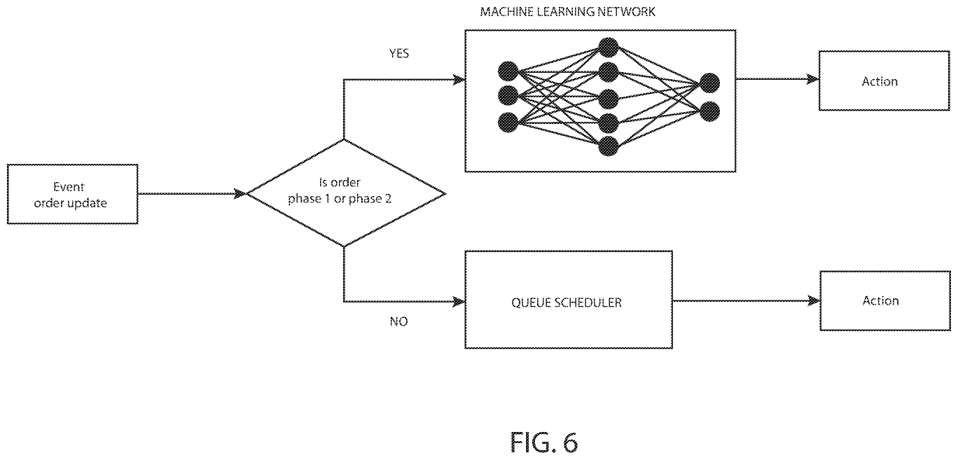

For the analysis of the hybrid approach, the authors implemented an agent trained with reinforcement learning for kitchen operations, while a queue-based agent was responsible for the couriers module, where the queue processed successive events in accordance with the fifo principle: it assigns orders to a courier and dispatches it, the operating diagram has been shown in FIG. 6 of the drawings. The authors also attempted to implement popular extensions of the DQN model and verified whether they improve the final result, but these did not achieve the expected results and the model achieved inferior results during evaluation than baseline. The verified extensions were: Dueling DQN, PER DON, NoisyNet DQN.

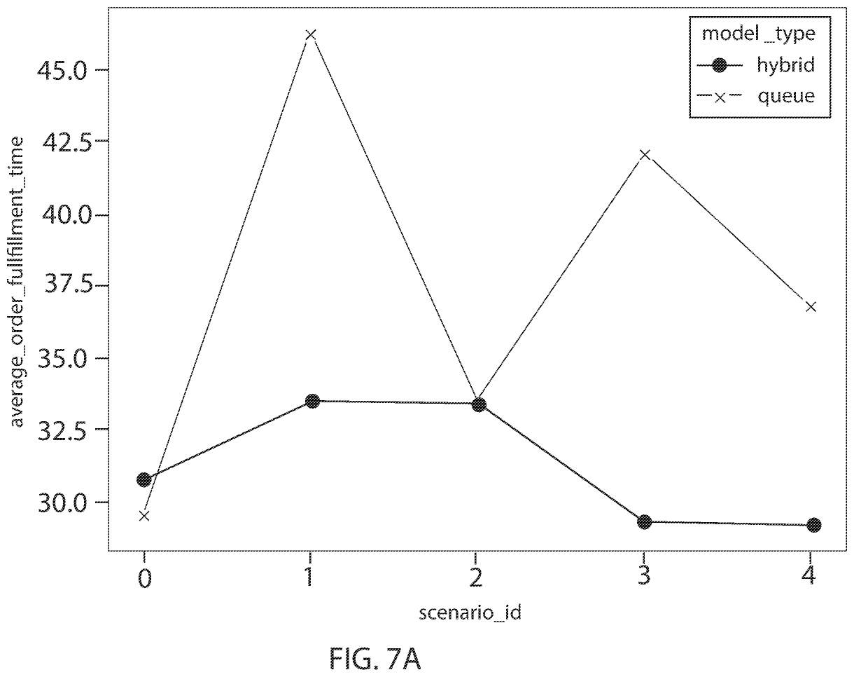

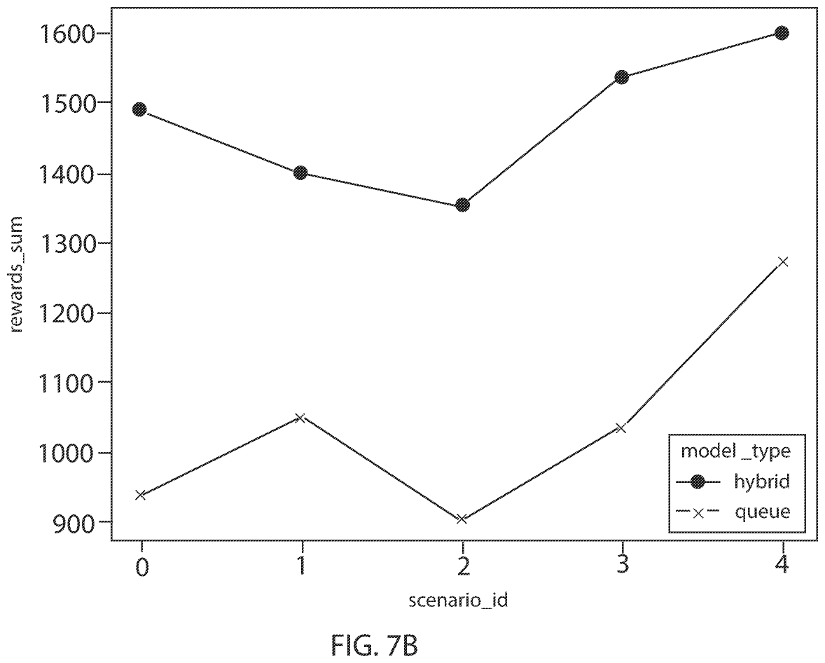

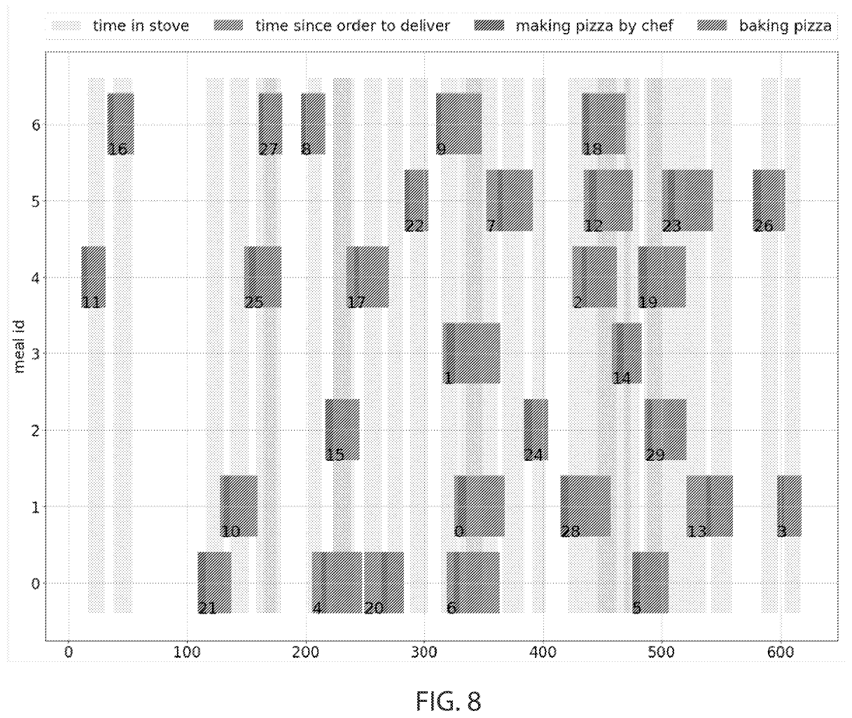

During evaluation with test scenarios, the hybrid model achieved better results than the model based exclusively on a queue, both in terms of the sum of rewards (the more the better) as well as in terms of the average order delivery time (the less the better), as shown in FIG. 7a, 7b of the drawings, where each point represents one of the test scenarios, FIG. 7a shows the average order delivery time during the performance of a given scenario, while FIG. 7b shows the sum of rewards received for each of the models. By averaging the obtained delivery times for each scenario, the authors received the following values: Hybrid, DQN+queue: 30.886 min, queue only: 37.443 min. The hybrid model attempts to deliver the incoming orders as soon as possible, both during stages executed by the kitchen—DQN model, as well as during the delivery process—the implementation of a queue, as shown in FIG. 8 of the drawings.

The data set intended for use in the hybrid model was prepared using data collected from restaurants operating on the basis of the ‘delivery’ model, such as user information (these could include employees, customers connected with a specific order), order delivery time, location, price, method of delivery, restaurant of origin, users connected with a specific order, restaurant information and its parameters, information on the order status modification times. This data is then processed in the following way: geographic coordinates are used to calculate the distance of each order from the restaurant, all time-related features are processed into a format understandable for the implemented model, with the averaged profiles related to couriers working for a given restaurant, e.g. the average speed, average delivery time, information on the status of couriers assigned to it. Data processed as above is divided in the proportions of 0.75/0.25 into training data and validation data, so that each row of data has the same probability of being assigned to a given data set. When receiving orders, new data (orders) are processed by the model and the time needed for the delivery of orders is calculated. Data collected from selected restaurants in this way can be considered as additional testing data.

The collected training data was used to test three models from the scikit-learn/xgboost library: namely XGBRegressor, RandomForestRegressor and AdaBoostRegressor. The process of learning of the presented models, because of the uniform library interface, can be reduced to the initiation of the fit method with the application of the specified data. The models were trained with the implementation of default parameters. After training they were compared with the Mean Absolute Error (MAE) profile, which corresponded with the absolute value of the difference between the predicted and actual delivery times. The XGBRegressor model provided the best results for training and validation data.

An example of the invention has been shown in the drawings, of which the individual figures reveal

FIG. 1 A schematic diagram of the simulator according to the invention

FIG. 2a, 2b TD-AC agent during an unsuccessful learning procedure

FIG. 3a, 3b Graphs showing the performance of agents using the SARSA method

FIG. 4a, 4b Graphs showing the performance of agents using the DQN method

FIG. 5a, 5b Graphs showing the performance of a DQN agent on a full simulator for a scenario with 30 orders delivered in one day

FIG. 6 The operational diagram of a hybrid model

FIG. 7a, 7b Comparative graphs between a hybrid model and a queue-based model

FIG. 8A graph showing the time of completion of individual phases of delivery in one of the test scenarios by a hybrid model

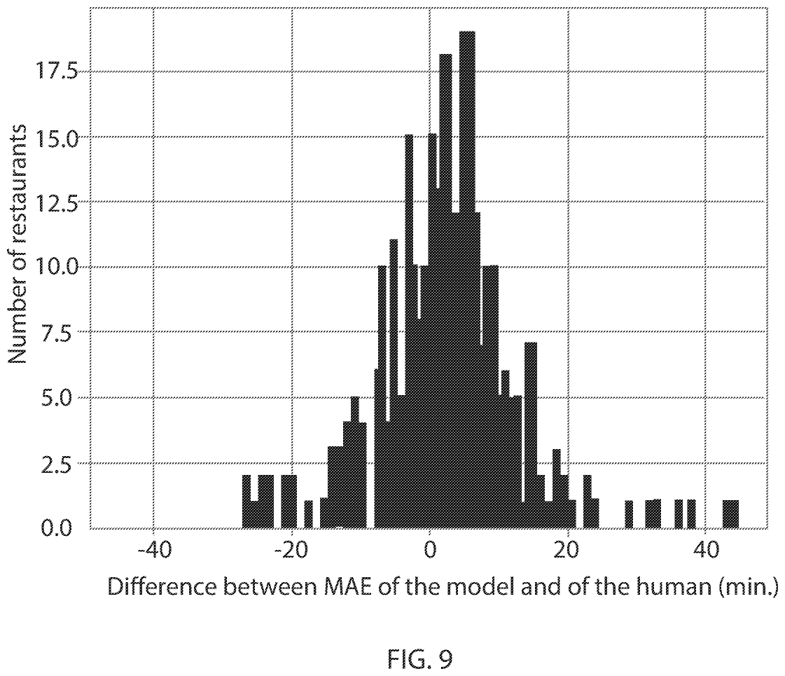

FIG. 9A graph showing model vs. employee differences in time prediction compiled during the implementation of method

The example of the method according to the invention used a method of automation of restaurant traffic management process, such as the reception of orders, preparation of meals by the restaurant's kitchen and the delivery of meals by couriers from the restaurant to clients located beyond the premises of the restaurant characterised in that quantitative data on the movement of restaurant kitchen personnel and on the movement of couriers was collected with the consideration of the different types of restaurants (pizza restaurants, dumpling bars, sushi bars, etc.), with the installation of a kitchen data acquisition system for the purpose of data collection. The above process enabled the acquisition of data on 9,401,228 unique orders related to 18,983,226 meals, as well as 1,070,901,979 GPS coordinates of the movement of couriers, with the subsequent identification of typical restaurant operations scenarios by way of the clustering and classification of this data. The data was then introduced into a simulator, where it was used for the purposes of a previously unknown series of orders placed during one day, wherein the individual meal preparation and courier travel times were drawn randomly from a statistical distribution that approximates the restaurant's kitchen personnel and courier movement data. The simulator consisted of the restaurant kitchen, delivery and configurator modules, wherein the restaurant kitchen module was a digital twin of a real restaurant kitchen and simulated its resources, their quantity, the main parameters and their dependencies, while the delivery module included data on the movement of couriers and its factors, whereas the configurator module included data on restaurant operating scenarios. Data from the simulator was then processed into data for the control of restaurant traffic with the use of two decision-making algorithms, where the decision-making algorithm for kitchen traffic was an algorithm based on a DQN-type temporal differences structure, while courier traffic was controlled by an algorithm based on a fifo queue structure. The average order delivery time for the DQN+queue model was 30.886 min. The verification process was based on the generation of training and test scenarios with predefined parameters and then the final model version was trained and evaluated using these scenarios. The average order delivery time was then calculated for each test scenario. The final reported value is the average of the values for all test scenarios. The average prediction error for the implemented model was 9.873 minutes, while the maximum prediction error was 10.834 minutes. The maximum value was calculated in the same way as the average error value (prediction of delivery times for selected actual delivery restaurants). An example of a histogram showing the differences in the accuracy of predictions according to the method and those made individually by a restaurant employee, has been shown in FIG. 9 of the drawings. It is defined by the following numerical values:

| Human - AI prediction | | |
|---|---|---|
| differences. (min) | No. of restaurants | % of all restaurants |
| 0 < −15 | 11 | 3.46 |
| 1 [−15, −5) | 46 | 14.47 |
| 2 [−5, 0) | 54 | 16.98 |
| 3 [0, 5) | 84 | 26.42 |
| 4 [5, 15) | 95 | 29.87 |
| 5 > 15 | 24 | 7.55 |

1. The method of automation of restaurant traffic management process, including the reception of orders, preparation of meals by the restaurant's kitchen and the delivery of meals by couriers from the restaurant to clients located beyond the premises of the restaurant, characterised in that
quantitative data on the movement of restaurant kitchen personnel and on the movement of couriers is collected and then typical restaurant operational scenarios are identified by way of the clustering and classification of this data,
the data is then introduced into a simulator, where it is used for the purposes of a previously unknown series of orders placed during one day, wherein the individual meal preparation and courier travel times are drawn randomly from a statistical distribution that approximates the restaurant's kitchen personnel and courier movement data,
wherein the simulator consists of the restaurant kitchen, delivery and configurator modules and the restaurant kitchen module is a digital twin of a real restaurant kitchen and simulates its resources, their quantity, the main parameters and their dependencies, the delivery module includes data on the movement of couriers and its factors, and the configurator module includes data on restaurant operating scenarios.
data from the simulator is then processed into data for restaurant traffic control with the use of at least one decision-making algorithm and can be applied for the management of restaurant traffic.

2. Method according to claim 1, characterised in that the decision-making algorithm is an algorithm based on a first-in-first-out queue structure.

3. Method according to claim 1, characterised in that the decision-making algorithm is a machine learning algorithm.

4. Method according to claim 3, characterised in that the machine learning algorithm is a reinforcement learning algorithm.

5. Method according to claim 4, characterized in that the reinforcement learning algorithm consists of at least one algorithm based on the Temporal Difference (TD) Learning structure.

6. Method according to claim 5, characterized in that the algorithm based on the Temporal Difference (TD) Learning structure is a DQN-type algorithm.

7. Method according to claim 5, characterized in that the algorithm based on the Temporal Difference (TD) Learning structure is a SARSA-type algorithm.

8. Method according to claim 5, characterized in that the algorithm based on the Temporal Difference (TD) Learning structure is an Actor-Critic (TD-AC) type algorithm.

9. Method according to claim 1, characterised in that the decision-making algorithm for kitchen traffic is an algorithm based on a DQN-type temporal differences structure, whereas for the courier traffic it is an algorithm based on the first-in-first-out queue structure.
